(19) United States
(12) Patent Application Publication
(10) Pub. No.: US 2002/0111893 A1
(43) Pub. Date: Aug. 15, 2002

(54) Computer network auction system useful in garnering the attention of individual network users

(76) Inventor: Sue L. Shifrin-Cassidy, Las Vegas, NV (US)

Correspondence Address: Quirk & Tratos, Suite 500 North, 3773 Howard Hughes Parkway, Las Vegas, NV, 89109, US

(21) Appl. No.: 09/782,822

(22) Filed: Feb. 13, 2001

(51) Int. Cl. G06F 17/60

(52) U.S. Cl. 705/37

(57) ABSTRACT

A method for directing the attention of persons from the general public to one or more sets of observable information utilizes the privilege of participating in a public auction as the compelling mechanism for inspecting the observable information sets. The privilege is earned by accumulating points for each observation visit to the information sets and to insure proper focus such visits may be guided by various clues or attention focusing devices, preferably in the form of a scavenger hunt or a treasure hunt. While the method is best carried with the aid of a computer assisted network, the information sets that are inspected may include the actual physical inspections of commercial facilities together with the inspection of network information.

### BACKGROUND OF THE INVENTION

1. Field of the Invention

The present invention relates to computer network implemented auction systems and more particularly to a system and method for effecting an interactive auction between subscribing bidders that is generally accessible to others for viewing.

2. Description of the Prior Art

In the recent past various techniques have been devised which in one way or another implement an auction process on a computer network. Various examples of such auction systems can be found in U.S. Pat. No. 5,890,138 to Godin et al, U.S. Pat. No. 5,835,896 to Fisher et al, U.S. Pat. No. 6,021,398 to Ausubel, and U.S. Pat. No. 6,078,906 to Huberman. The same public access to a computer network that has made network auctions such a commercial success has also created competition for the attention of the individual network user and attention brokerage is now a major component in any commercial use of the network. This strong interest in attention garnering permeates most network communication, and ‘hit’ counters on ‘web’ pages are a common occurrence.

The interest in reaching new prospective customers is exhibited everyplace. Accordingly, various novel techniques have been proposed for drawing prospective consumers to view a particular advertiser's message and examples of such techniques can be found in U.S. Pat. No. 5,794,210 to Goldhaber et al, U.S. Pat. No. 6,119,098 to Guyot et al, and others. While suitable for the purposes intended the foregoing examples fail to take benefit of some of the compelling aspects of human conduct.

The marketplace has been rendered particularly convenient by the emergence, and now wide acceptance, of the computer assisted network. Network effected securities trading, airline ticket reverse bidding and all sorts of other auction techniques are now part of the landscape. Nonetheless, while each of the foregoing attention garnering endeavors offers various brilliant solutions in its field of focus, the compelling aspects of an auction itself have not been put to effective use. Simply, the implementation challenges of the various network auction formats have masked the usefulness of the auction process for attention garnering.

Auctions have long been recognized as interest inducing, and even compelling, market mechanisms. The competitive character of the auction, the potential for a windfall, the various nuances and interplays during the bidding, and the perception that in the end the auction price offers a true reflection of value, all combine to draw in participants. There is also the spectators' curiosity in the auction dynamics themselves, e.g., the timing interval between competing bids, the bid increment, the various bidding personalities and the subject of the bidding itself are all matters of compelling interest. Like a well played sports event drawing spectators to participate in the sport, the same irresistible attributes often draw the auction spectators to participate in the sport of auctions. The use of an auction as a mechanism for other attention garnering is therefore particularly advantageous, and it is one such process that is disclosed herein.

### SUMMARY OF THE INVENTION:

Accordingly, it is the general purpose and object of the present invention to provide a computer network based interactive auction accessible for passive observation from other processing systems connected to the network.

Other objects of the present invention are to provide an auction system effected in a computer network that may be passively monitored by others.

Yet further objects of the present invention are to provide an attention garnering entry sequence to qualify as a participant in an electronic auction.

Briefly these and other objects are accomplished within the present invention by providing a computer network auction system defined by an “auctioneer,” or auction conducting processor, communicating by way of a publicly accessible network with a plurality of qualified bidders each served by “subscribing” processors. Preferably the “auctioneer” processor includes a secure, interactive process with the various subscribing processors along with generally accessible logical sequences identifying the bidder, the amount of the bid and the image of the article that is the subject of the auction. Those skilled in the art will appreciate that while these bidding particulars may be generally published, the bidding process itself needs to be isolated in secure formats and/or by encryption to limit all possibility of any mischief or interference. Accordingly, the generally published part of the inventive network auction serves to publicize the participants whose entry to the walled-off bidding process may include a variety of qualification requirements. These can be attention garnering processes themselves, and a symbiotic exchange is therefore inherent in the inventive process.

This symbiosis is particularly effective in the instances where the auction process is devoted to raise funds for a charity. In this setting the qualifying bidders would each be required to contribute to the charity a specified donation before they will be allowed to bid, while other donors may be invited to contribute interesting items as the articles or services that will be auctioned. The combination of the invited bidding personalities, the bidding process and the unique auction articles all produce a compelling attention garnering impetus.

This attention garnering attribute of the inventive auction system may also serve as the carrying vehicle for various advertising messages. In the case of a charity auction this further aspect multiplies the charity revenue stream by way of advertising fees. Those in the art will appreciate that computer network hosted advertising fees are now paid with some regularity, typically on the bases of a numerical count of “visitors” to the advertiser's site. The “host” that exposes to large numbers of visitors the advertisers' banners will therefore command substantial fees.

In the instant invention this particular revenue mechanism is further enhanced by allowing those that first only observe the auction to earn points that may be accumulated and then credited in lieu of the bidders' entry fee. This point earning sequence may take the form of a process analogous to a scavenger hunt, through the various advertisers' sites, or even the advertisers' business facilities. Once the observer earns enough hunt points in this manner he or she is then allowed to cross the wall and join the ranks of the auction bidders. Even further revenue multiples can be realized by sheer exhaustion of the weaker scavenger hunting candidates.

In this manner the attention compelling attributes of an auction process are synergistically enhanced by directing the observing auction candidates through parallel attention focusing reviews of various advertisements that, in the end, increase even further the ranks of those participating in the auction. This truly symbiotic mechanism has not been used to advantage in the past.

### BRIEF DESCRIPTION OF THE DRAWINGS

FIG. 1 is a diagrammatic illustration of a computer network implemented for displaying and interactive participation in an auction process in accordance with the present invention;

FIG. 2 is an illustration of one video screen image useful with the present invention;

FIG. 3 is an exemplary instruction sequence flow chart of a logical process by which new bidders are accredited and admitted to the secure bidding channels of the present invention;

FIG. 4 is a diagrammatic illustration of the signal paths effected in the course of the inventive process set out herein;

FIG. 5 is a further instruction sequence flow chart of the logical sequence that is carried out in the course of earning qualification points for admission to the sequence shown in FIG. 3; and

FIG. 6 is yet another flow chart of the logical sequence associated with the bidding that is carried out in the course of the inventive auction process.

### DESCRIPTION OF THE PREFERRED EMBODIMENT

The present invention takes benefit and incorporates in its processes the architecture and implementation of a computer communication network currently referred to by the name “Internet.” Generally, the Internet is but one example of computer assisted communication between various computers or other communication devices tied to a common network and no limitation is intended by this reference. In these arrangements the network usually includes its support systems, in the form of data paths or channels, various data storage facilities or servers, and other system components, which rely for their funding on the revenues paid by ‘commercial speech’ users. Of course, as the density of commercial speech on the network has increased need arose for various attention garnering or focusing mechanisms. Concurrently, convenient access to the network by the general public was also obtained with the result that virtually anyone with a personal computer that is seeking matters of varying interest can now do so on the network. With this increase in popularity vigorous competition has evolved for the attention of this user, and fees are now regularly paid for drawing such attention to one or another source of commercial speech.

The concluding part of all this commercial speech on the network has also evolved various interactive processes which, until now, were purely local. All sorts of interactions between distant parties are now regularly effected on the network, and even the auction process is now possible at a distance. The same interactive attributes allow for sharing of processing tasks, and the evolved network architecture now also entails distributed processing.

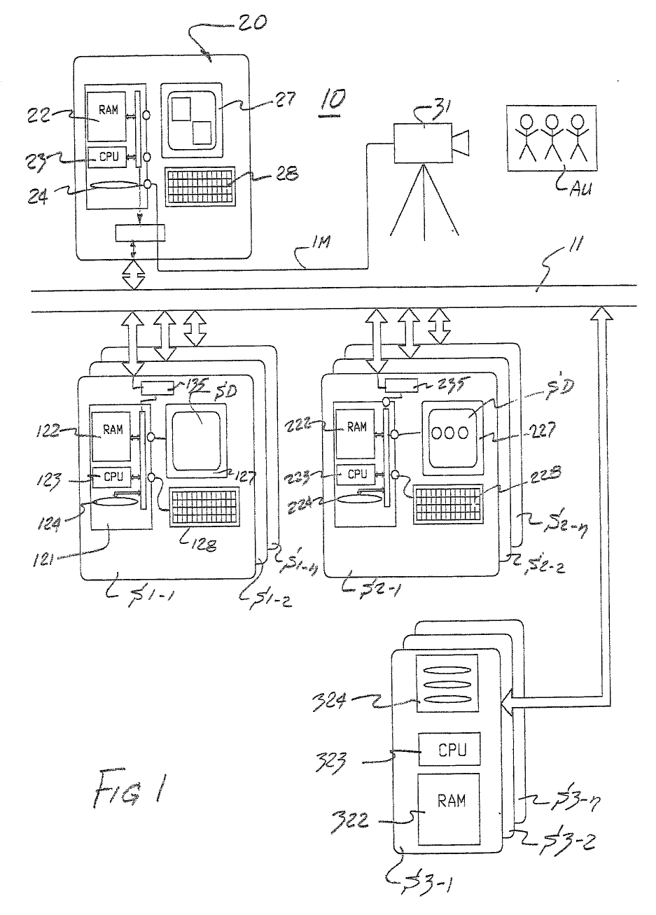

As shown in FIGS. 1 through 6 the inventive auction system, generally designated by the numeral 10, utilizes a conventional computer network 11 accessible to all those desiring to communicate thereon. One such communicating system is the inventive auction managing system, generally shown at 20, implemented by way of conventional data processing system, or computer, 21 comprising a temporary memory RAM 22, a central processing unit CPU 23, a permanent memory in the form of a disc drive 24 and a bus 25 connected therebetween. In conventional practice the auction managing system 20 may also be implemented with its own video display 27 and a keyboard 28 through which instructions and directives can be manually effected. Also associated with the auction managing system 20 may be a video camera 31 directed to record the images of a live auction AU being conducted in real time, its image signals IM being periodically scanned into the process that is conducted within the data processing system 21. All these functions, coordinated as a sequence of data and control signals on bus 25, interact with network 11 through signal matching devices like a MODEM 35.

A plurality remote processing stations grouped as stations S1-1 through S1-n and S2-1 through S2-n are also tied for communication on network 11 as are a plurality of large data storage facilities shown as servers S3-1 through S3-n. Like numbered parts functioning in like manner, each of the remote processing stations within their groups is provided with their own corresponding processing stages 121 and 221, respectively including a RAM 122 and 222, CPU 123 and 223, disc file 124 and 224 and bus 125 and 225. Similarly, each of the remote processing stations within the respective groups is provided with a corresponding video monitor 127 and 227, keyboards 128 and 228 and MODEM interfaces 135 and 235 to communicate on the network 11.

Those skilled in the art will appreciate that the respective architectures of each of the processing stages 21, 121 and 221 generally conform to the conventional architectures of known data processing systems. In each instance, therefore, the general flow of data and its processing are well appreciated and no extensive explanations are needed. Moreover, while the example is illustrated in unitary data processing forms, more general, distributed configurations are both extensively known and extensively practiced. This network expansion of all data processing to distributed forms is well appreciated and is best illustrated by devices known as servers.

Accordingly, also illustrated herein in an arrangement tied to network 11 are a plurality of servers S3-1 through S3-n, each including its disc storage assembly 324 rendered operative by its resident instruction sequences or programs under the control of its CPU 323 and with the assistance of its temporary memory or RAM 322. The data storage capacity of the disc storage assemblies is massive and is usually adapted to function as a support adjunct to the network itself, providing each user a virtual expansion of his or her permanent storage files which remain accessible all the time. Amongst these users are also those that wish to transmit commercial speech and whose network addresses are defined by a common convention of uniform resource locators, or URLs, including those that are willing to pay for each inspection by others.

One will appreciate that the system arrangement illustrated in FIG. 1 includes separations selected by the functional architecture of the inventive auction process. In this arrangement the auction management stage 20 interacts in both directions with the distributed bidders that may be serviced by the remote processing systems S1-1 through S1-n. Since the auction process entails financial transactions that are sometimes quite large, a fair amount of security screening and isolation is necessary for any data exchange between each of these bidder systems and the auction managing stage. This same security screening also shields the bidding process from external interference and mischief. Along with these well-secured communication signal paths are also the less secure, general utility signal paths between remote stations S2-1 through S2-n and network 11. These may also include a part of the signal array that is issued from the auction managing system 20 which includes the images and other information from the auction that is of interest to the general public.

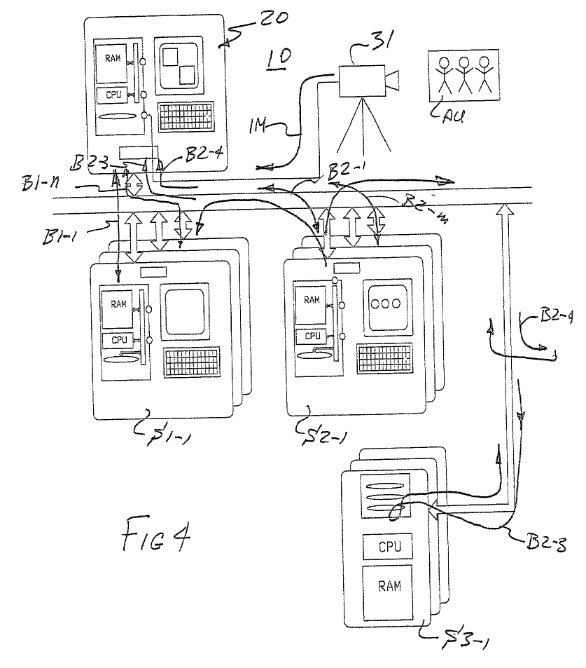

These same signal path directions are illustrated separately in FIG. 4. In this illustration the signal exchanges necessary for the effective conduct of the auction are shown as bidirectional signal exchanges BI-1 through BI-n respectively between the remote systems S1-1 through S1-n and the auction managing system 20. Each of these signals is heavily encrypted and screened, shown by way of encryption decoders or filters F1-1 through F1-n respectively. At the same time the managing system 20 is publishing one-directional signals B2-1 through B2-m onto network 11 which are unencrypted and therefore available to all including the observing systems S2-1 through S2-n.

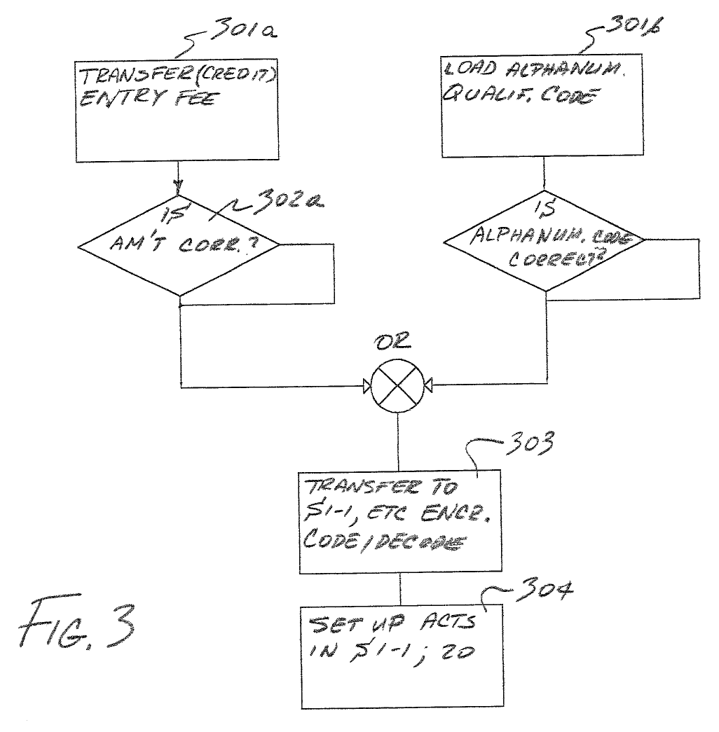

Thus there are two levels of involvement, one as an observer and the second as a participant. To obtain accreditation from observer status to the ranks of a participant, reference should be had to the instruction sequence 300 illustrated in FIG. 3, which may be a routine that is resident in disc 24 of the managing system 20. In steps 301 a and 301b of this sequence a logical OR is effected where either a cash credit transaction in the amount necessary to qualify as a bidder is paid to the auction account or a specified alphanumeric code is transmitted from the remote system that is seeking to qualify. Each one of these conditions is then tested in the parallel steps 302a and 302b and, if either is true, then the process advances to step 303 in which the encryption decoding and encoding tables or algorithms are transferred from the system 20 disc file 24 to the qualifying remote system S1-1 through S1-n. Concurrently, in step 304 offsetting accounting rubrics are set up in both the bidder's account and in the auction account. The remote station is thus now qualified to be a bidder.

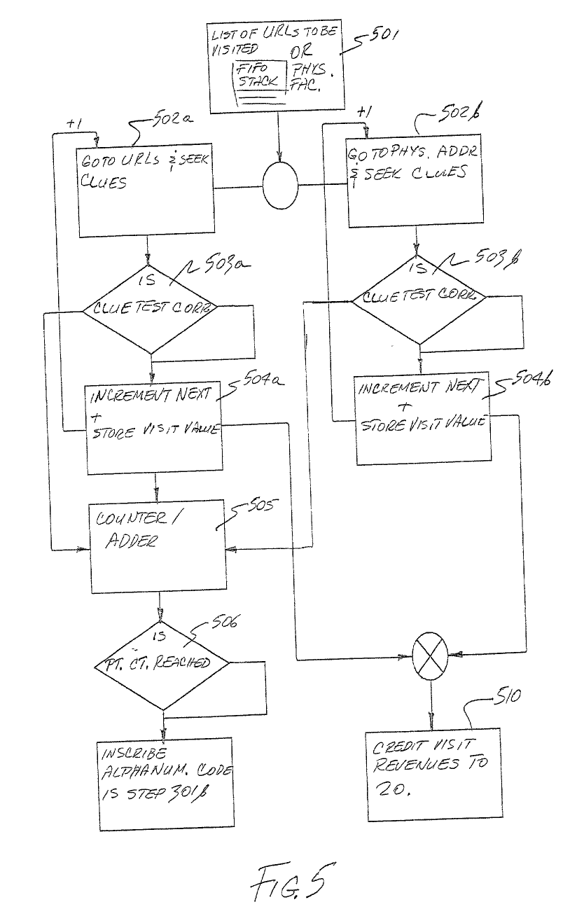

The process for obtaining the alphanumeric code that is tested in step 302b is best illustrated by reference to FIGS. 4 and 5. Generally, in the course of this process the observer that desires to be advanced to the ranks of the bidders, i.e., the user of one of the remote systems S2-1 through S2-n, may download from the managing system 20 yet another sequence 500 which in its initial step 501 includes a set of conditions that must be achieved by this user. These may be arranged as a progressive stack, e.g., a logical AND sequence, or may be without a progressive order and may also include various alternative options, in the form of a logical OR. As an example, and not intended as a limitation, the AND sequence may include an instruction set in step 502a to access a particular site address, or URL, and thereafter identify information on the site that corresponds with a particular set of clues, i.e., the familiar treasure or scavenger hunt. These clues may themselves be arranged in an AND stack or sequence tested in each instance in step 503a and incremented in step 504a until the final sequence step is encountered. At that point a specific number of credits is added to the user's credit counter/adder in step 505.

Alternatively, the user may elect to examine the instruction set branched to step 502b which may include the requirement that the user actually visit a particular physical business facility and thereafter satisfy the sequence of tests or inquiries in step 503b until all the inquiries are advanced through step 504b and the corresponding point credit is booked into step 505. Then in step 506 the total number of points is compared and, if it meets or exceeds the qualifying point count, then in step 507 the alphanumeric code is assigned to the user which is inscribed into 301b. The remote system on which this sequence is effected is then advanced into the ranks of the bidders and can hereinafter be referred to as one of the accredited systems S1-1 through S1-n.

In parallel with this accreditation process the incrementing steps 504a and 504b are each also branched to a revenue accumulating step 510 in which the earnings that obtained by these ‘hits’ or visits are accumulated to the account or benefit of the auction managing system 20. Thus the auctioneer keeps accumulating cash credit regardless of the successful completion of the respective treasure hunts by the various candidates.

To illustrate this credit accumulation the signal path B2-3, in FIG. 4, is shown as looped through server S3-1 in which, for example, the particular URL associated with the treasure hunt in step 502a may have its information stored. Alternatively, the signal path B2-4 may branch outside the confines of the network and may include the above referred physical site visits. Those in the art will appreciate that these signal arrangements are illustrative only as the information that is distributed on the network may have several physical locations or may be simply a set of pointers to a particular interface. More importantly, signals B2-3 and B2-4 are each associated with a hit counter on the host web site of the inventive auction, and the difficulty of the scavenger hunt sequence is useful both to increase the number of repetitive ‘hits’ and to assure an adequate inspection detail during each such hit.

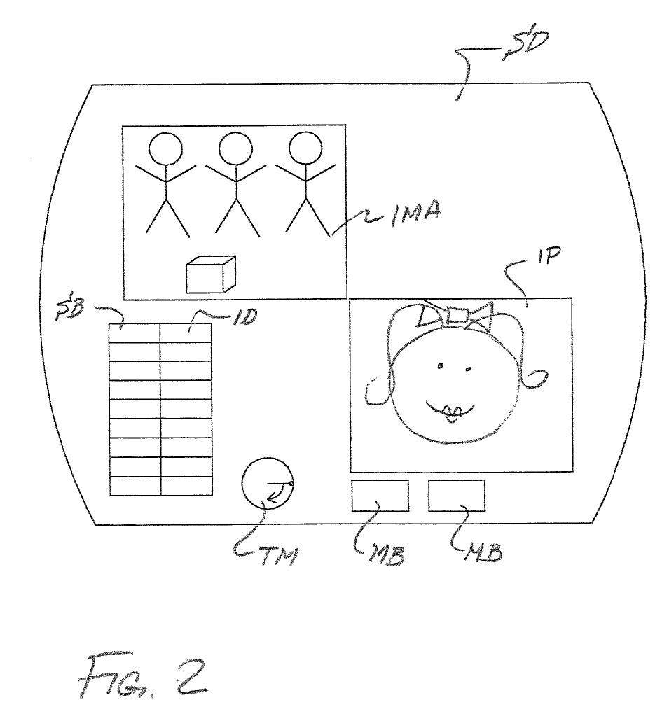

Referring again to FIG. 2 the screen display SD that is accessible to all that communicates with the network 11 includes an image IMA corresponding to the auction image that is captured as signal IM by the video camera 31. Also listed on the screen display SD may be the current bidding sequence record shown as a column of sequential bids SB adjacent the bidders identity ID. For those bidders that are famous personalities and/or that may wish to enhance the auction process by their image, a further image pattern of their likeness IP may also be displayed on the screen SD. Along with this information there may be further information accessible through menu buttons MB (or similar other known devices) by which the candidate can ascertain the current state of the auction including the beginning inventory, the inventory still remaining, the prevailing bidding prices, and even the time TM left to bid.

The accreditation may involve a substantial payment to the account of the auction manager and, in the instances of a charity auction, those making or effecting such substantial charity contributions may correctly want to obtain some recognition therefor, which is provided herein. The accredited bidders may therefore want and elect to be recognized by his or her image display in the course of bidding. Of course, those that are not so disposed may elect a fictitious designation, or may simply omit a designation completely. Moreover, the bidding process itself is displayed in real time including the bidder's identity, the amount of the bid and the time warnings of an “auctioneer.” In this setting the other aspects may be more compelling at any given time than the bidder's identity. Thus all of the attention garnering attributes of the auction process are continuously available to the observers, and loss or omission of some has little impact on the process.

Those in the art will appreciate that the foregoing sequences may be combined with other, overlaid sequences that may occur in parallel. Thus various advertising banners may be displayed directly on the screen display SD along with the auction information previously described. Each of these banners becomes, in accordance with the currently prevailing practice, a link to the advertisers' pages and each time the link is involved an agreed fee is credited in favor of the “host provider.” This accumulation of fees is without a concurrent credit to any one candidate, but nonetheless, may be in itself a significant source of revenue.

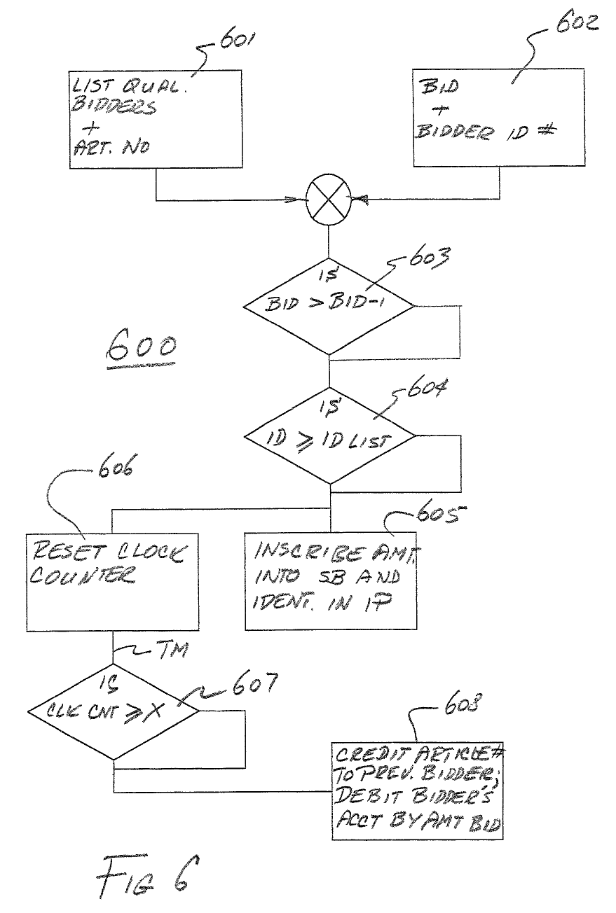

The managing system 20 also coordinates the events of the bidding process, effected by way of a sequence that is again resident in the disc 24. More precisely, as shown in FIG. 6, the coordinating process, generally designated by the numeral 600, in step 601 loads the list of the qualified bidders and the article number of the item currently auctioned. Each of the bids for the article is then serially loaded into step 602 with a concurrent test in step 603 to see if the current bid is greater than the last preceding bid. This test accommodates any network communication delays or simply slow processing that may result in delays in the bid arrival. If the bid sequence is correct a test is effected in step 604 for a match between the bidder's identity and the list of accredited bidders. The bid amount and the bidder identity are then inscribed as signals SB and IP in step 605 and concurrently displayed on the screen SD. At the same time a clock count is reset in step 606 which is also displayed as a time remaining image TM on the screen. In step 607 this time count is tested for a maximum count and once this count is reached, then in step 608 the item is credited to the winning bidder while his or her account is debited by the bid amount.

It should be noted that the foregoing process lends itself to various levels of attention focus. For example the clues on the scavenger hunt clue list may be intentionally left somewhat ambiguous, compelling a close scrutiny of the whole of the advertisers' text. Of course the point score assigned to such an ambiguous set of clues would necessarily be high as would be the incremental cost to the subscribing advertiser. Similarly the clue may require that an inspection extends all the way to the end of the advertising message, again increasing the unit fee charged by the host system and also the point score. There may also be preferred web page locations that the advertiser wishes to have exposed, and so on. The clue selection process thus allows various focusing options to the advertiser and therefore a more predictable attention garnering mechanism.

Those in the art will appreciate that the logical processes described herein may be variously distributed and/or apportioned amongst the several processing devices tied to the network. For example the whole logical sequence may be stored in the memory of the managing system 20 in one of the system languages like the Standard Generalized Markup Language (SGML) useful in networked computer systems. Alternatively, the logical sequence may be resident in one of the server S3-1 through S3-n to be involved by its Uniform Resource Locator, or URL, and the advertisers' text may be similarly found by its URL designation. Morever, there may be interactive inquiry sequences that are involved as a part of the scavenger search of the advertisers' pages by which the candidate observer is selected into a pool of customer prospects, thus assisting in the creation of various customer lists, and so on.

Simply, the number of useful variants that are obtained from this inventive process is myriad, and it is therefore intended that the scope of the instant invention be determined solely by the claims appended hereto.

It is claimed:

1. A method for accrediting potential bidders to an auction carried on a computer network, comprising the steps of:
publishing on the network the particulars of said auction, including the description of the article that is auctioned off and the bidding that is currently associated with said article;
setting out a first sequence of instructions directing the examinations of one or more advertisements on said computer network;
accumulating a first predetermined number of earned points to the benefit of a particular potential bidder upon the compliance by said potential bidder with said instructions directing the examination of said advertisements; and
accrediting said potential bidder to become a qualified bidder in said auction upon the accumulation of said earned points that is greater than a preselected number of points.

2. A method according to claim 1, comprising the further steps of:
setting out a second sequence of instructions directing the examinations of one or more business facilities described on said computer network; and
accumulating a second predetermined number of earned points to the benefit of said particular bidder upon the compliance by said potential bidder with said instructions directing the examination of each said business facilities.

3. A method according to claim 2, wherein:
said step of accrediting said potential bidder includes the further step of accumulation of said first and second earned points.

4. A method according to claim 1, comprising the further step of:
providing a list of subscribing bidders each qualified to participate in said auction by virtue of a payment of an entry fee; and
said step of publishing on said network the particulars of said auction includes the bidding particulars of said subscribing and said qualified bidders.

5. A method according to claim 4, comprising the further steps of:
setting out a second sequence of instructions directing the examinations of one or more business facilities described on said computer network; and
accumulating a second predetermined number of earned points to the benefit of said particular bidder upon the compliance by said potential bidder with said instructions directing the examination of each said business facility.

6. A method according to claim 5, wherein:
said step of accrediting said potential bidder includes the further step of accumulation of said first and second earned points.

7. A method for accrediting potential bidders to an auction carried on a network, comprising the steps of:
publishing on the network the particulars of said auction, including the description of the article that is auctioned off and the bidding that is currently associated with said article;
setting out a first sequence of instructions directing the examinations of one or more advertisements on said network;
setting out a second sequence of instructions directing the examinations of one or more business facilities described on said network;
accumulating a first predetermined number of earned points to the benefit of a particular potential bidder upon the compliance by said potential bidder with said instructions directing the examination of said advertisements;
accumulating a second predetermined number of earned points to the benefit of said particular bidder upon the compliance by said potential bidder with said instructions directing the examination of each said business facility; and
accrediting said potential bidder to become a qualified bidder in said auction upon the accumulation of said first and second earned points that is greater than a preselected number of points.

8. A method according to claim 7, wherein:
said network is a computer assisted communication network; and
said auction is effected by interactive computer assisted communications on said network.

9. A method according to claim 8, comprising the further step of:
providing a list of subscribing bidders each qualified to participate in said auction by virtue of a payment of an entry fee; and
said step of publishing on said network the particulars of said auction includes the bidding particulars of said subscribing and said qualified bidders.

10. A method of garnering the attention of such persons as may be viewing information generally distributed by a network to view specified part or portion of said information, comprising the steps of:
publishing on the network the particulars of an auction, including the description of the article that is auctioned off, the identities of the bidders that are currently participating in said auction, and the bidding that is currently associated with each said article;
setting out a first sequence of instructions directing the examinations of one or more of said specified parts or portions of said information on said network;
accumulating a first predetermined number of earned points to the benefit of a particular one of said persons upon the compliance by said person with said instructions directing the examination of said parts or portions of said information; and
accrediting each said person to become a qualified bidder in said auction upon the accumulation of said earned points that is greater than a preselected number of points.

11. A method according to claim 10, wherein:
said network is a computer assisted communication network; and
said auction is effected by interactive computer assisted communications on said network.

12. A method according to claim 11, comprising the further step of: providing a list of subscribing bidders each qualified to participate in said auction by virtue of a payment of an entry fee; and
said step of publishing on said network the particulars of said auction includes the bidding particulars of said subscribing and said qualified bidders.

13. A method according to claim 10, comprising the further steps of:
setting out a second sequence of instructions directing the examinations of one or more business facilities described on said network; and
accumulating a second predetermined number of earned points to the benefit of said person upon the compliance by said potential bidder with said instructions directing the examination of each said business facility.

14. A method according to claim 13, wherein:
said step of accrediting each said person includes the further step of accumulation of said first and second earned points.

15. A method according to claim 10, comprising the further step of:
providing a list of subscribing bidders each qualified to participate in said auction by virtue of a payment of an entry fee; and
said step of publishing on said network the particulars of said auction includes the bidding particulars of said subscribing and said qualified bidders.

16. A method according to claim 15, comprising the further steps of:
setting out a second sequence of instructions directing the examinations of one or more business facilities described on said network; and
accumulating a second predetermined number of earned points to the benefit of said person upon the compliance by said person with said instructions directing the examination of each said business facilities.

17. A method according to claim 16, wherein:
said step of accrediting said person as a qualified bidder includes the further step of accumulation of said first and second earned points.

18. A method according to claim 17, wherein:
said network is a computer assisted communication network; and
said auction is effected by interactive computer assisted communications on said network.

19. A method according to claim 18, comprising the further step of:
providing a list of subscribing bidders each qualified to participate in said auction by virtue of a payment of an entry fee.

20. A method according to claim 19, comprising the further step of:
said step of publishing on said network the particulars of said auction includes the bidding particulars of said subscribing and said qualified bidders.
